(19) United States
(12) Patent Application Publication
(10) Pub. No.: US 2020/0191061 A1
(43) Pub. Date: Jun. 18, 2020

(54) INTEGRATED ADDITIVE BLADDER FOR CHARGING AND INSULATION OF SMALL ATTRITABLE ENGINE

(71) Applicant: United Technologies Corporation, Farmington, CT (US)

(72) Inventors: Jesse R. Boyer, Middletown, CT (US); Lawrence Binek, Glastonbury, CT (US); Om P. Sharma, South Windsor, CT (US); Evan Butcher, Suffield, CT (US); Bryan G. Dods, Greer, SC (US); Vijay Narayan Jagdale, South Windsor, CT (US)

(73) Assignee: United Technologies Corporation, Farmington, CT (US)

(21) Appl. No.: 16/222,049

(22) Filed: Dec. 17, 2018

(51) Int. Cl. F02C 7/272; F01D 25/24; F02C 7/32

(52) U.S. Cl. CPC F02C 7/272; F01D 25/24; F05D 2210/12; F05D 2260/85; F02C 7/32

(57) ABSTRACT

An attritable gas turbine engine casing unitary charging volume comprising a casing having an interior wall and an exterior wall opposite the interior wall; a unitary charging volume formed between the exterior wall and the interior wall.

### BACKGROUND

The present disclosure is directed to a casing having a unitary charging volume and insulation for attritable engine applications.

Attritable or expendable propulsion systems have a short lifespan relative to typical flight applications. The attritable engine is utilized for a limited lifespan and disposed. The attritable gas turbine engine may not even be operated through a full operational cycle. The attritable gas turbine engine may only perform start-up, and operational load before being decommissioned.

Since the operational modes of the attritable gas turbine engine may be significantly less than the conventional gas turbine engine, the attritable engine does not need to meet the same durability or safety requirements as the conventional gas turbine engine. Conventional gas turbine engine manufacturing techniques deployed for attritable engines can be more costly and more complex than needed. Since conventional manufacturing techniques can be more costly, additive manufacturing techniques may be deployed in substitute to reduce cost and complexity of the attritable gas turbine engine.

For a prior art small attritable engine E as shown in FIG. 1, the gas turbine engine E requires a charge of compressed air to initially start the gas turbine engine E. The initial charge of compressed air requires a portable volume of air to start the engine. This volume is conventionally held in a separate pressure vessel V attached to the attritable engine E. The separate pressure vessel V adds weight, cost and part count to the attritable engine design.

Additionally, the small attritable engine E as shown in FIG. 1, includes a separate insulation blanket B wrapped around the casing. The insulation blanket B reduces the heat transfer from the hot sections located inboard of the gas turbine engine to the exterior of the casing. The insulation blanket B is also an additional part or can be multiple parts assembled with the attritable gas turbine engine E.

What is needed is an additively integrated bladder with the casing for attritable engine applications that can eliminate the need for a separate pressure vessel to contain the initial charge of air or a separate insulating blanket for thermal management of the engine.

### SUMMARY

In accordance with the present disclosure, there is provided an attritable gas turbine engine casing unitary charging volume comprising a casing having an interior wall and an exterior wall opposite the interior wall; a unitary charging volume formed between the exterior wall and the interior wall.

In another and alternative embodiment, the unitary charging volume is configured to contain a predetermined charge of compressed air utilized to initiate a start-up of the attritable gas turbine engine.

In another and alternative embodiment, the attritable gas turbine engine casing unitary charging volume further comprises at least one spar extending between the interior wall and the exterior wall within the unitary charging volume.

In another and alternative embodiment, the attritable gas turbine engine casing unitary charging volume further comprises a coupling attached to the casing configured to attach a source of compressed air to receive a charge of compressed air for the casing unitary charging volume.

In another and alternative embodiment, the unitary charging volume is unitary with the casing.

In another and alternative embodiment, the unitary charging volume is located integrally throughout the casing.

In another and alternative embodiment, the unitary charging volume comprises the same material composition as the casing.

In accordance with the present disclosure, there is provided a casing with a unitary charging volume for an attritable gas turbine engine comprising the unitary charging volume defined within the casing of the gas turbine engine; the unitary charging volume comprising an exterior wall and an interior wall opposite the exterior wall; and the unitary charging volume being formed integrally with the casing.

In another and alternative embodiment, the unitary charging volume comprises a structure formed unitary with the casing configured to insulate the attritable gas turbine engine.

In another and alternative embodiment, the unitary charging volume is located integrally throughout the casing.

In another and alternative embodiment, the unitary charging volume is configured to contain a predetermined charge of compressed air utilized to initiate a start-up of the attritable gas turbine engine.

In another and alternative embodiment, the unitary charging volume comprises the same material composition as the casing.

In another and alternative embodiment, the casing with a unitary charging volume further comprises at least one spar extending between the interior wall and the exterior wall within the unitary charging volume.

In accordance with the present disclosure, there is provided a process for forming an attritable gas turbine engine casing with a unitary charging volume comprising forming a casing having an interior wall and an exterior wall opposite the interior wall; forming a unitary charging volume integral with the casing between the interior wall and the exterior wall, wherein the unitary charging volume is configured to contain a predetermined charge of compressed air utilized to initiate a start-up of the attritable gas turbine engine.

In another and alternative embodiment, forming the casing and the unitary charging volume comprises model-based additive manufacturing techniques.

In another and alternative embodiment, the step of forming the unitary charging volume comprises changing process parameters to produce the unitary charging volume within the casing between the interior wall and the exterior wall.

In another and alternative embodiment, the process further comprises determining the insulation value of the unitary charging volume.

In another and alternative embodiment, the unitary charging volume comprises the same material composition as the casing.

In another and alternative embodiment, the process further comprises determining a predetermined internal stress of the unitary charging volume; building a file generator; and determining the finite element solution of the internal stress.

In another and alternative embodiment the process further comprises locating at least one spar between the interior wall and the exterior wall responsive to the steps of determining the predetermined internal stress of the unitary charging volume.

There is an opportunity to leverage additive manufacturing (AM) techniques to improve various aspects of these limited-life products' lifecycles. These aspects include unitizing assembly details, integration of complex performance-enhancing features, lowering production costs, and reducing time to delivery; typically prohibitive when leveraging conventional manufacturing techniques.

Other details of the casing unitary charging volume and insulation are set forth in the following detailed description and the accompanying drawings wherein like reference numerals depict like elements.

### BRIEF DESCRIPTION OF THE DRAWINGS

FIG. 1 an isometric view of a schematic representation of a prior art attritable gas turbine engine.

FIG. 2 is an isometric view of a schematic representation of an exemplary attritable gas turbine engine.

FIG. 3 is a schematic representation of a cross section of an exemplary attritable gas turbine engine casing with unitary charging volume and insulation.

### DETAILED DESCRIPTION

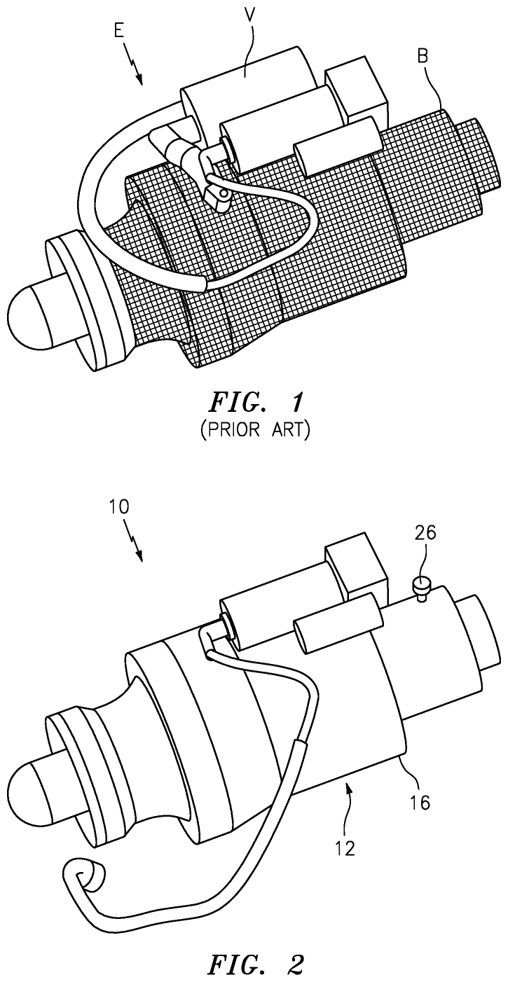

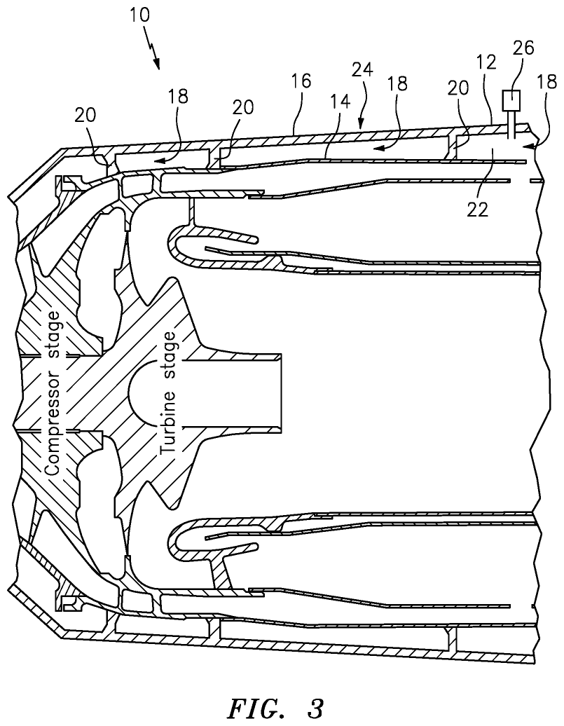

Referring now to FIG. 2 and FIG. 3, there is illustrated an exemplary attritable gas turbine engine 10, with a compressor stage and a turbine stage. The turbine engine section 10 can include a casing 12. The casing includes an interior wall 14 and an exterior wall 16 defining a cavity or bladder or charging volume 18 between the interior wall 14 and exterior wall 16. The casing unitary charging volume 18 is configured to contain a predetermined charge of compressed air utilized to initiate start-up of the gas turbine engine 10.

The interior wall 14 and exterior wall 16 can be coupled and supported by spars 20 that are configured to structurally support the casing unitary charging volume 18. The casing unitary charging volume 18 can be constructed as a single or as multiple separate compartments 22 throughout the casing 12. The spars 20 can allow for air to pass from compartment 22 to compartment 22.

The casing unitary charging volume 18 is unitary with the casing 12. The casing unitary charging volume 18 can be located integrally throughout the casing 12. The casing unitary charging volume 18 can also serve as insulation 24 for the gas turbine engine 10. The casing unitary charging volume 18 has excellent thermal insulating properties due to the limited convection from limited fluid flow through the casing unitary charging volume 18. The insulating properties of the casing unitary charging volume 18 can be maintained after the initial compressed charge of air is utilized to start the gas turbine engine, since the casing unitary charging volume 18 will be substantially devoid of compressed air. The casing unitary charging volume 18 serves to reduce heat transfer from the hotter interior wall 14 to the cooler exterior wall 16.

A coupling 26 can be coupled to the casing 12, such as at the exterior wall 16. The coupling 26 can be configured to attach a source of compressed air (not shown) to receive the charge of compressed air for the casing unitary charging volume 18. In an exemplary embodiment, the charge of compressed air can be sized to provide an impulse of energized air sufficient to start the gas turbine engine. A predetermined charge of compressed air can be utilized to initiate the start-up of the attritable gas turbine engine. Discharged gas from the unitary charging volume is configured to exit into the structure prior or at the compressor stage. This will result in the rotative assembly to rotate. The gas charge would be sized to the rotative assembly so as to generate enough rotational inertia.

The casing unitary charging volume 18 can be formed along with the casing 12 by use of additive manufacturing. In an exemplary embodiment, the casing unitary charging volume 18 can be formed utilizing model-based additive manufacturing techniques. Those exemplary additive manufacturing techniques can include changing process parameters to produce the casing unitary charging volume and insulation 18 within the casing 12.

In an exemplary embodiment, the casing 12 with the unitary charging volume 18 can be formed as one utilizing model-based additive manufacturing techniques. The additive manufacturing techniques can include changing process parameters to produce the unitary charging volume 18 within the casing 12 between the interior wall 14 and the exterior wall 16. The additive manufacturing techniques can include determining the insulation value of the unitary charging volume. Dimensioning the unitary charging volume to accommodate that insulation value. The additive manufacturing techniques can include determining predetermined an internal stress of said unitary charging volume, building a file generator; and determining the finite element solution of the internal stress. The analysis above can help with locating at least one spar between said interior wall and said exterior wall.

Additive manufacturing of the unitary charging volume can be done employing direct energy deposition or laser powder bed fusion. Using direct energy deposition, it is possible to build sections of the structure in dissimilar metals which are weldable. A laser powder bed approach would result in the unitary charging volume, integrated with the wall casings being built at the same time.

The casing unitary charging volume and insulation provides the advantage of customization of the internal geometry of the additive bladder for unique insulating efficiencies via heat exchanging/insulating features.

The casing unitary charging volume and insulation provides the advantage of utilizing additive manufacturing to enable thin walls and a capability to create complex geometries not traditionally achievable via casting or machining.

The casing unitary charging volume and insulation provides the advantage of geometries to potentially customize the insulating needs of the attritable engine.

The casing unitary charging volume and insulation provides the advantage of cost reduction via the reduction of the number of parts and assembly.

There has been provided a casing with an integral additive bladder for charging volume and insulation for attritable engine applications. While the casing unitary charging volume and insulation has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. An attritable gas turbine engine casing unitary charging volume comprising:
a casing having an interior wall and an exterior wall opposite said interior wall;
a unitary charging volume formed between said exterior wall and said interior wall.

2. The attritable gas turbine engine casing unitary charging volume according to claim 1, wherein said unitary charging volume is configured to contain a predetermined charge of compressed air utilized to initiate a start-up of the attritable gas turbine engine.

3. The attritable gas turbine engine casing unitary charging volume according to claim 1, further comprising:
at least one spar extending between said interior wall and said exterior wall within said unitary charging volume.

4. The attritable gas turbine engine casing unitary charging volume according to claim 1, further comprising:
a coupling attached to the casing configured to attach a source of compressed air to receive a charge of compressed air for the casing unitary charging volume.

5. The attritable gas turbine engine casing unitary charging volume according to claim 1, wherein said unitary charging volume is unitary with the casing.

6. The attritable gas turbine engine casing unitary charging volume according to claim 1, wherein said unitary charging volume is located integrally throughout the casing.

7. The attritable gas turbine engine casing unitary charging volume according to claim 1, wherein said unitary charging volume comprises the same material composition as said casing.

8. A casing with a unitary charging volume for an attritable gas turbine engine comprising:
the unitary charging volume defined within said casing of the gas turbine engine;
the unitary charging volume comprising an exterior wall and an interior wall opposite said exterior wall; and
the unitary charging volume being formed integrally with said casing.

9. The casing with a unitary charging volume according to claim 8, wherein said unitary charging volume comprises a structure formed unitary with the casing configured to insulate said attritable gas turbine engine.

10. The casing with a unitary charging volume according to claim 9, wherein said unitary charging volume is located integrally throughout the casing.

11. The casing with a unitary charging volume according to claim 8, wherein said unitary charging volume is configured to contain a predetermined charge of compressed air utilized to initiate a start-up of the attritable gas turbine engine.

12. The casing with a unitary charging volume according to claim 8, wherein said unitary charging volume comprises the same material composition as said casing.

13. The casing with a unitary charging volume according to claim 8, further comprising:
at least one spar extending between said interior wall and said exterior wall within said unitary charging volume.

14. A process for forming an attritable gas turbine engine casing with a unitary charging volume comprising:
forming a casing having an interior wall and an exterior wall opposite said interior wall;
forming a unitary charging volume integral with said casing between said interior wall and said exterior wall, wherein said unitary charging volume is configured to contain a predetermined charge of compressed air utilized to initiate a start-up of the attritable gas turbine engine.

15. The process of claim 14, wherein forming said casing and said unitary charging volume comprises model-based additive manufacturing techniques.

16. The process of claim 14, wherein forming said unitary charging volume comprises:
changing process parameters to produce said unitary charging volume within said casing between said interior wall and said exterior wall.

17. The process of claim 16, further comprising:
determining the insulation value of the unitary charging volume.

18. The process of claim 14, wherein said unitary charging volume comprises the same material composition as said casing.

19. The process of claim 14, further comprising:
Determining a predetermined internal stress of said unitary charging volume;
building a file generator; and
determining the finite element solution of the internal stress.

20. The process of claim 19, further comprising:
locating at least one spar between said interior wall and said exterior wall responsive to the steps of claim 19.
